(19) United States
(12) Patent Application Publication
(10) Pub. No.: US 2018/0178765 A1
(43) Pub. Date: Jun. 28, 2018

(54) BRAKE ASSIST SYSTEM AND METHOD

(71) Applicant: GM GLOBAL TECHNOLOGY OPERATIONS LLC, Detroit, MI (US)

(72) Inventors: IDO ZELMAN, RA'ANANA (IL); AVSHALOM SUISSA, KIRYAT ONO (IL)

(73) Assignee: GM GLOBAL TECHNOLOGY OPERATIONS LLC, Detroit, MI (US)

(21) Appl. No.: 15/392,933

(22) Filed: Dec. 28, 2016

(51) Int. Cl. B60T 7/22

(52) U.S. Cl. CPC B60T 7/22; B60T 2210/32

(57) ABSTRACT

A vehicle braking system integrates information regarding relative distance and velocity of both a preceding vehicle/obstacle and a proceeding vehicle in order to execute a braking scheme that optimizes the operating distance between the host vehicle to both the preceding vehicle/obstacle and the proceeding vehicle.

### TECHNICAL FIELD

This patent generally relates to vehicle braking systems, and more particularly, this patent relates to a vehicle braking assist system that implements a braking scheme that accounts for preceding and proceeding vehicles/obstacles, and to vehicles incorporating such systems and schemes.

### BACKGROUND

Vehicles for the road, such as passenger cars, trucks and vans, incorporate braking systems to slow and ultimately stop the vehicle during normal use. These systems interpret one or more inputs, such as a user command, a semi-autonomous or autonomous vehicle operation command, and the like, to execute a physical response of the braking system to reduce vehicle speed. Vehicle speed may be reduced by converting kinetic energy of the vehicle to heat, by recovering and storing the kinetic energy and combinations thereof.

The vehicle may further include systems that enhance or assist the braking system both during user commanded or semi-autonomous/autonomous commanded operation. One type of braking system assist is obstacle avoidance. Obstacle avoidance systems utilize one or more systems of forward looking sensors to detect obstacles within the vehicle's intended path and whether, given the state of motion of the vehicle, an encounter with the obstacle is possible. The obstacle avoidance system may cause application of the braking system, among other actions, to slow or stop the vehicle in order to avoid the obstacle.

While braking assist systems such as obstacle avoidance reduce the likelihood of the vehicle encountering an obstacle, upon slowing or stopping the vehicle may itself become an obstacle to other vehicles operating in the vicinity. Accordingly, it is desirable to provide within a vehicle a braking assist a system that reduces the likelihood of the vehicle encountering a vehicle/obstacle as well as the vehicle being encountered by another vehicle operating near the vehicle. Furthermore, other desirable features and characteristics of the devices, systems and methods of the herein described exemplary embodiments will become apparent from the subsequent detailed description and the appended claims, taken in conjunction with the accompanying drawings and the foregoing technical field and background.

### SUMMARY

In another non-limiting exemplary embodiment, a brake assist system for a vehicle is operably coupled to a brake system of the vehicle to affect deceleration and stopping of the vehicle. The brake assist system includes a first sensor arranged to provide first data indicative of a distance and relative velocity of a first obstacle forward of the vehicle, and a second sensor arranged to provide second data indicative of a distance and relative velocity of a second obstacle rearward of the vehicle. A braking assist module is operably coupled to receive the first and second data, and to affect deceleration of the vehicle via the brake system in accordance with a braking scheme based upon the first data and the second data.

In another non-limiting exemplary embodiment, a vehicle includes a brake assist system to affect deceleration and stopping of the vehicle. The brake assist system includes a first sensor arranged to provide first data indicative of a distance and relative velocity of a first obstacle forward of the vehicle, and a second sensor arranged to provide second data indicative of a distance and relative velocity of a second obstacle rearward of the vehicle. A braking assist module is operably coupled to receive the first and second data and to affect deceleration of the vehicle via the brake system in accordance with a braking scheme based upon the first data and the second data.

In another non-limiting example, a method of decelerating and stopping a vehicle includes determining from first data and second data, the first data indicative of a distance and relative velocity of a first obstacle forward of the vehicle and the second data indicative of a distance and relative velocity of a second obstacle rearward of the vehicle, a stopping distance between the vehicle and the first obstacle and the vehicle and the second obstacle. Within the stopping distance, the vehicle is stopped.

### DESCRIPTION OF THE DRAWINGS

The exemplary embodiments will hereinafter be described in conjunction with the following drawing figures, wherein like numerals denote like elements, and wherein:

FIGS. 1-3 are graphic illustrations of a host vehicle relative to a preceding vehicle/obstacle and a proceeding vehicle, the vehicle being operable in accordance with one or more of the herein described embodiments to execute a braking scheme;

FIG. 4 is a schematic illustration of a brake system including a brake assist module in accordance with one or more of the herein described embodiments;

FIG. 5 is a graphic depiction of a braking scheme in accordance with the herein described exemplary embodiments; and

FIG. 6 is a flow chart depicting a braking scheme in accordance with a herein described embodiment of the invention.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term system or module may refer to any combination or collection of mechanical and electrical hardware, software, firmware, electronic control component, processing logic, and/or processor device, individually or in any combination, including without limitation: application specific integrated circuit (ASIC), an electronic circuit, a processor (shared, dedicated, or group), memory that executes one or more software or firmware programs, a combinational logic circuit, and/or other suitable components that provide the described functionality.

The exemplary embodiments may be described herein in terms of functional and/or logical block components and various processing steps. It should be appreciated that such block components may be realized by any number, combination or collection of mechanical and electrical hardware, software, and/or firmware components configured to perform the specified functions. For example, an exemplary embodiment may employ various combinations of mechanical components and electrical components, e.g., integrated circuit components, memory elements, digital signal processing elements, logic elements, look-up tables, or the like, which may carry out a variety of functions under the control of one or more microprocessors or other control devices. In addition, those skilled in the art will appreciate that embodiments described herein may be practiced in conjunction with any number of mechanical and/or electronic systems, and that the vehicle systems described herein are merely exemplary embodiment.

For the sake of brevity, conventional components and techniques and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a herein described embodiment.

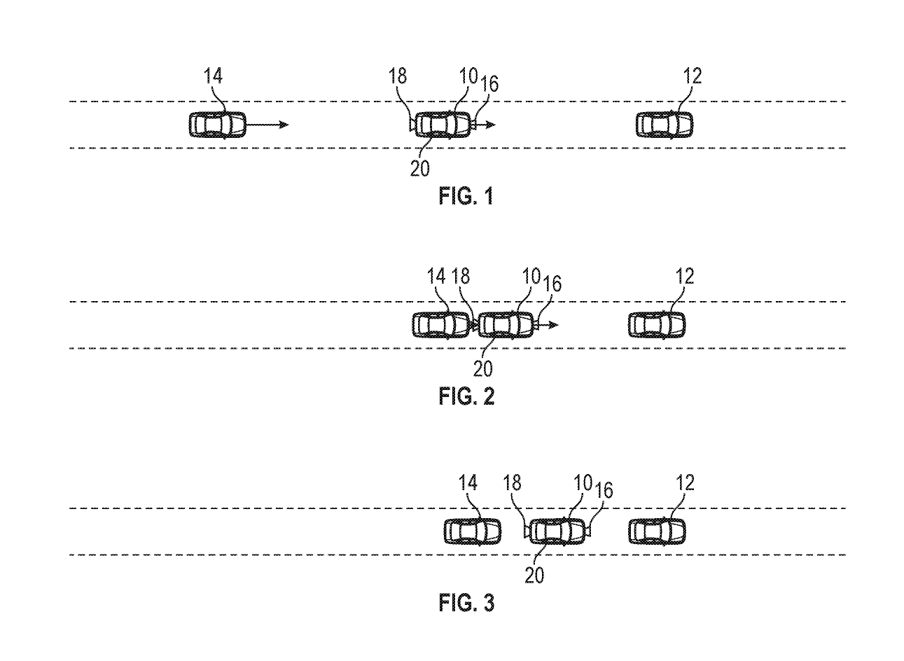

FIGS. 1-3 illustrate a host vehicle 10 operating relative to a preceding vehicle 12 and a proceeding vehicle 14. The vehicles 10, 12 and 14 are operating with appropriate spacing relative to each other for the given speed of each. At least the vehicle 10 is fitted with a forward looking sensor system 16 and a rearward looking sensor system 18; the terms forward and rearward being as shown in the Figs. for the vehicle 10 and its direction of travel and not limiting of the described exemplary embodiment.

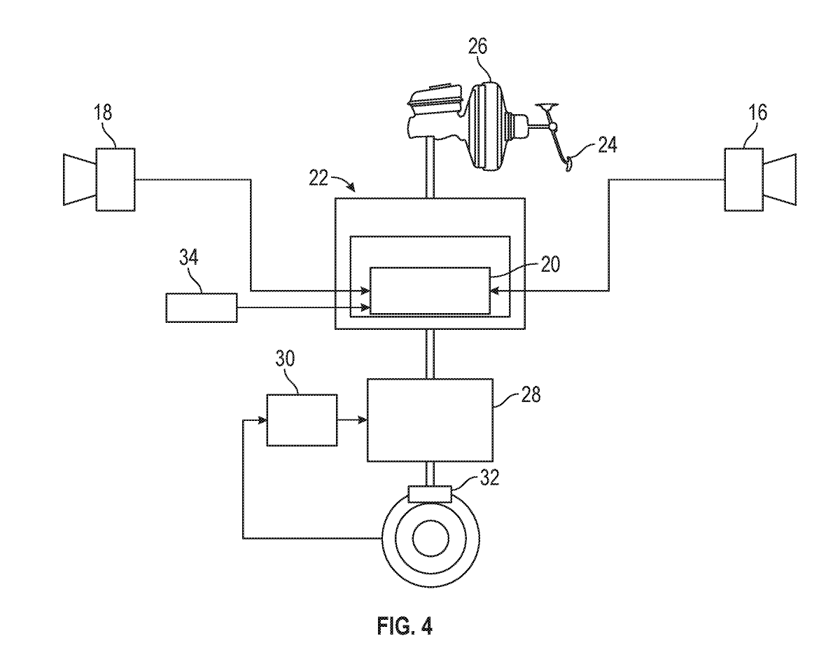

Referring to FIG. 4, the sensor systems 16 and 18 may be optical, RADAR, LIDAR, ultrasonic, or any suitable type sensor or combination of sensors operable to provide data indicative of the position and motion of an obstacle, e.g., vehicle 12 and vehicle 14, relative to the vehicle 10. The sensor systems 16 and 18 provide data to a brake assist unit 20 within the vehicle 10. The brake assist unit 20 is operably disposed within the braking system 22 of the vehicle 10. The braking system 22 may otherwise be conventional and include an operator actuated brake pedal 24 coupled to a boost unit 26 in communication with a hydraulic unit 28 with associated anti-lock braking unit 30. The hydraulic unit 28 is in fluid communication with brake components, e.g., calipers, rotors and pads and/or drums and linings, generally depicted as components 32, disposed at the wheels of the vehicle 10 (not depicted). The braking system 22 and the brake assist unit 20 may further be operable coupled to or in communication with other vehicle systems and controllers, and an exemplary electronic control unit (ECU) 34 is depicted.

Referring again to FIGS. 1-3, preceding vehicle 12 begins to slows suddenly under braking. The host vehicle 10 in response to the rapid declaration of the vehicle 12 initiates rapid deceleration via determined braking effort. The braking action of the host vehicle 10 may be as a result of the operator applying strong pressure to the brake pedal 24, or in a semi-autonomous or autonomous mode of operation, the braking system 22 may be actuated to provide a high level of braking action via an autonomous vehicle controller (not depicted) within the vehicle 10. Therefore both vehicles 10 and 12 begin to decelerate rapidly. In response to the braking action of the host vehicle 10, the operator or an autonomous controller (not depicted) of the proceeding vehicle 14 also initiates braking action.

With reference to FIG. 4, the sensor system 16 provide distance (Fx) and relative velocity (Fv) data of the vehicle 10 relative to the vehicle 12 to the braking assist unit 20. The sensor system 18 similarly provides distance (Bx) and relative velocity (Bv) data of the vehicle 10 relative to the vehicle 14 to the braking assist unit 20. The braking assist unit 20 and the sensor systems 16 and 18 may operate continuously with the operation of the vehicle, may operate responsive to application of the braking system 22, with activation of a semi-autonomous or autonomous operating mode or under other suitable conditions. As one of skill in the art will appreciate, the braking assist unit 20 and sensor systems 16 and 18, while depicted as separate and autonomous components and systems of the vehicle 10, may be implemented into other vehicle systems such as an active speed control, a semi-autonomous vehicle controller and/or an autonomous vehicle controller within the scope of the herein described embodiments.

The braking assist unit 20 is operable to modulate an output of the brake hydraulic unit 28 to affect a change, either to increase or decrease, the rate of deceleration of the vehicle 10. While not depicted, the braking assist unit 20 may also cooperate with energy recovery systems (not depicted) further to modulate deceleration of the vehicle 10 to avoid encountering the vehicle 12 and to enhance the likelihood the vehicle 14 will not encounter the vehicle 10.

In accordance with the herein described embodiments, the braking assist unit 20 executes a braking scheme that optimizes the operating distance between the host vehicle 10 to both the preceding vehicle 12 or other obstacle and the proceeding vehicle 14. For example, the braking assist unit 20 may execute upon data received from the sensor systems 16 and 18 as well as data received from other vehicle systems, e.g. controller 34, to decrease the probability of occurrence that the proceeding vehicle 14 encounters the host vehicle 10 from behind while concomitantly increasing the likelihood that the host vehicle 10 itself avoids encountering the vehicle 12. In cases where an encounter cannot be avoided, the braking assist system can minimize the effect of contact between the vehicle 10 with either or both of vehicles 12 and 14.

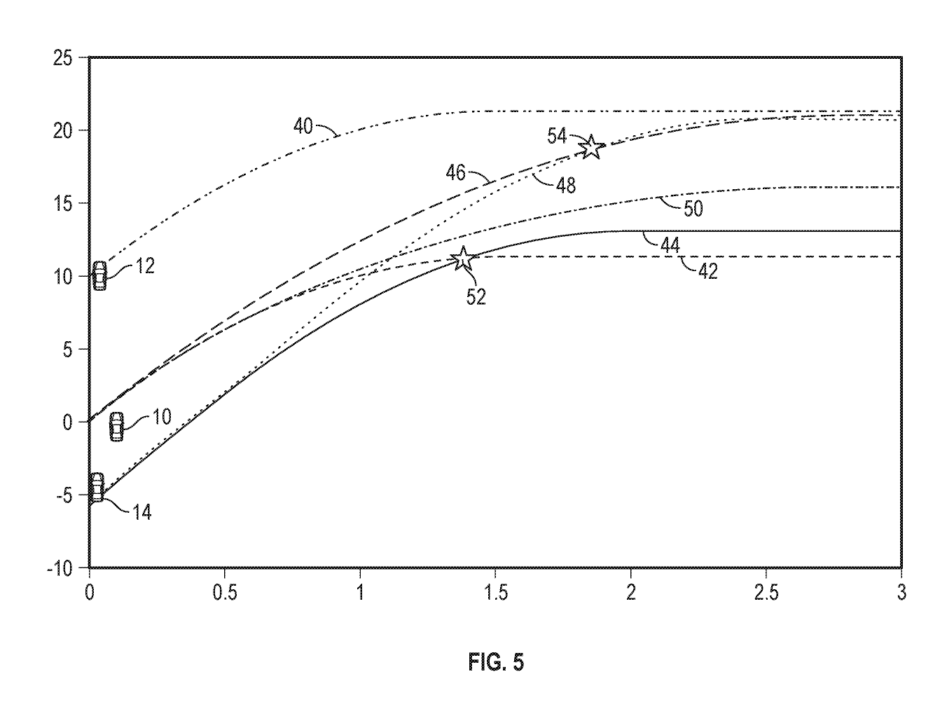

With reference to FIG. 5, several braking scenarios involving vehicles 10, 12 and 14 are depicted graphically. In each scenario, the braking of vehicle 12 is depicted by the trace 40. A first scenario of the braking of vehicles 10 and 14 is depicted by traces 42 and 44, respectively, in FIG. 5. The vehicle 10 responds to the braking of vehicle 12 with a reaction time, t₁₀₋₁, accounting only for the relative distance and velocity of itself to vehicle 12. It is able to decelerate and come to a complete stop avoiding vehicle 12 by a distance, d₁₀₋₁. The vehicle 14 responds to the braking of vehicle 10 with a reaction time, t₁₄₋₁, but is unable to stop prior to encountering vehicle 10 at 52, notwithstanding potentially applying maximum braking effort to affect maximum deceleration.

A second scenario of the braking of vehicles 10 and 14 is depicted by traces 46 and 48, respectively, in FIG. 5. The vehicle 10 responds to the braking of vehicle 12 with a reaction time, t₁₀₋₂, accounting only for the relative distance and velocity of itself to vehicle 12. It is able to slow and come to a complete stop using less braking effort avoiding vehicle 12 by a distance, d₁₀₋₂. By braking relatively gently, vehicle 10 does not provide sufficient indication to vehicle 14 that it needs to decelerate and stop quickly. The vehicle 14 responds to the braking of vehicle 10 with a reaction time, t₁₄₋₂, but is unable to stop prior to encountering vehicle 10 at 54, notwithstanding potentially applying maximum braking.

A third scenario of the braking of vehicle 10 is depicted by trace 50 while vehicle 14 brakes according to trace 44 as depicted in FIG. 5. The vehicle 10 responds with a reaction time, t₁₀₋₁. Utilizing data from sensors 16 and 18, the braking assist module 20 intervenes to account for the relative distance and velocity of itself to vehicle 12 (Fₓ and Fᵥ) and of itself to vehicle 14 (Bₓ and Bᵥ). In response to the braking of the vehicle 12, vehicle 10 is able to slow and come to a complete stop potentially using less than maximum braking effort avoiding vehicle 12 by a distance, d₁₀₋₃. The vehicle 14 responds to the braking of vehicle 10 with a reaction time, t₁₄₋₃. Bᵥ optimizing and taking maximum advantage of the available distance (Fₓ) between vehicle 10 and vehicle 12, vehicle 10 is able to avoid vehicle 12 while providing additional distance (Bᵥ) and allowing vehicle 14 to stop at a distance, d₁₄₋₃, without encountering vehicle 10.

In situations in which the total available distance between the vehicle 12 and the vehicle 14, representing the total available distance within which to control the braking of vehicle 10 to avoid encounters with either or both of the vehicle 12 and vehicle 14, an encounter by vehicle 10 with one or both of vehicle 12 and vehicle 14 may be unavoidable. In contrast to a single, potentially higher energy encounter between vehicle 10 and either vehicle 12 or vehicle 14, the braking assist unit 20 may modulate the brake system 22 to control encounters of vehicle 10 with both vehicle 12 and vehicle 14 to minimize the effect of both encounters.

Thus it will be appreciated that in accordance with the herein described embodiments, a vehicle braking integrates information regarding relative distance and velocity of both a preceding vehicle/obstacle and a proceeding vehicle in order to execute a braking scheme that controls deceleration of the vehicle to optimize the operating distance between the host vehicle to both the preceding vehicle/obstacle and the proceeding vehicle. In another non-limiting exemplary embodiment, a braking assist system may include a brake assist unit operably coupled to forward looking and rearward looking sensor systems to execute upon data received from the sensors and data received from other vehicle systems to decrease the probability of situations in which a proceeding vehicle encounters the host vehicle from behind, particularly during emergency braking as the host vehicle itself attempts to avoid encountering a vehicle/obstacle. In cases where an encounter cannot be avoided, the system can minimize the effect.

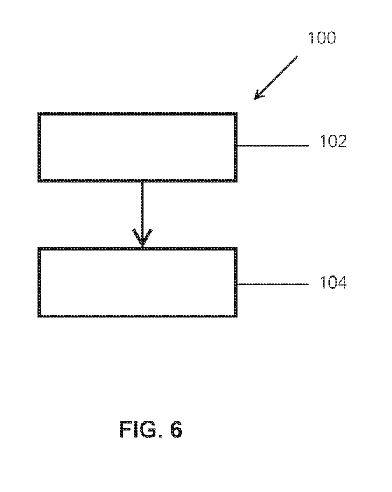

With reference to FIG. 6, a method 100 of decelerating and stopping a vehicle is shown. The vehicle may be in accordance with the herein described embodiments, such as vehicle 10. In this regard, the vehicle 10 may include a brake system 22 and a brake assist system 20 operably coupled to the brake system 22. The brake assist system 20 may further include a first sensor 16 arranged to provide first data indicative of a distance and relative velocity of a first obstacle, e.g., vehicle 12, forward of the vehicle 10, and a second sensor 18 arranged to provide second data indicative of a distance and relative velocity of a second obstacle, e.g, vehicle 14 rearward of the vehicle 10. At 102 from the first data and the second data a stopping distance between the vehicle and a preceding vehicle and the vehicle and a proceeding vehicle is determined. At 104, the vehicle is stopped within the stopping distance. The stopping distance may be such that an encounter of the vehicle 10 with the first obstacle or the second obstacle is avoided. Alternatively, the stopping distance may be such that an encounter of the vehicle 10 with the first obstacle or second obstacle is minimized. In alternate embodiments, a rate of deceleration of the vehicle 10 may be modulated. In still another alternative a rate of deceleration may be limited to less than a maximum rate of deceleration.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A brake assist system for a vehicle, the vehicle including a brake system to affect deceleration and stopping of the vehicle, the brake assist system being operably coupled to the brake system, the brake assist system comprising:
a first sensor arranged to provide first data indicative of a distance and relative velocity of a first obstacle forward of the vehicle;
a second sensor arranged to provide second data indicative of a distance and relative velocity of a second obstacle rearward of the vehicle;
a braking assist module operable coupled to receive the first and second data, the braking assist module being operable to affect deceleration of the vehicle via the brake system in accordance with a braking scheme based upon the first data and the second data.

2. The brake assist system of claim 1, wherein the braking scheme accounts for an available operating distance between the vehicle and the first obstacle and the vehicle and the second obstacle such that an encounter of the vehicle with the first obstacle or the second obstacle is avoided.

3. The brake assist system of claim 1, wherein the braking scheme accounts for an available operating distance between the vehicle and the first obstacle and the vehicle and the second obstacle such that an encounter of the vehicle with the first obstacle and the second obstacle is avoided.

4. The brake assist system of claim 1, wherein the braking scheme accounts for an available operating distance between the vehicle and the first obstacle and the vehicle and the second obstacle such that an encounter of the vehicle with the first obstacle or second obstacle is minimized.

5. The brake assist system of claim 1, wherein brake assist system modulates a rate of deceleration of the vehicle.

6. The brake assist system of claim 1, wherein the brake assist system limits a rate of deceleration to less than a maximum rate of deceleration.

7. A vehicle comprising a brake assist system, the vehicle including a brake system to affect deceleration and stopping of the vehicle, the brake assist system being operably coupled to the brake system, the brake assist system comprising:
a first sensor arranged to provide first data indicative of a distance and relative velocity of a first obstacle forward of the vehicle;
a second sensor arranged to provide second data indicative of a distance and relative velocity of a second obstacle rearward of the vehicle;
a braking assist module operable coupled to receive the first and second data, the braking assist module being operable to affect deceleration of the vehicle via the brake system in accordance with a braking scheme based upon the first data and the second data.

8. The vehicle of claim 7, wherein the braking scheme accounts for an available operating distance between the vehicle and the first obstacle and the vehicle and the second obstacle such that an encounter of the vehicle with the first obstacle or the second obstacle is avoided.

9. The vehicle of claim 7, wherein the braking scheme accounts for an available operating distance between the vehicle and the first obstacle and the vehicle and the second obstacle such that an encounter of the vehicle with the first obstacle and the second obstacle is avoided.

10. The vehicle of claim 7, wherein the braking scheme accounts for an available operating distance between the vehicle and the first obstacle and the vehicle and the second obstacle such that an encounter of the vehicle with the first obstacle or second obstacle is minimized.

11. The vehicle of claim 7, wherein brake assist system modulates a rate of deceleration of the vehicle.

12. The vehicle of claim 7, wherein the brake assist system limits a rate of deceleration to less than a maximum rate of deceleration

13. The vehicle of claim 7, the vehicle comprising a system controller, and the brake assist system being operably couple to the system controller.

14. A method of decelerating and stopping a vehicle, the vehicle having a brake system and a brake assist system operably coupled to the brake system, the brake assist system including a first sensor arranged to provide first data indicative of a distance and relative velocity of a first obstacle forward of the vehicle, and a second sensor arranged to provide second data indicative of a distance and relative velocity of a second obstacle rearward of the vehicle, the method comprising:
determining from the first data and the second data a stopping distance between the vehicle and the first obstacle and the vehicle and the second obstacle; and
stopping the vehicle within the stopping distance.

15. The method of claim 14, wherein the stopping distance is such that an encounter of the vehicle with the first obstacle or the second obstacle is avoided, and the method comprises stopping the vehicle within the stopping distance avoiding an encounter with the first obstacle and the second obstacle.

16. The method of claim 14, wherein the stopping distance is such that an encounter of the vehicle with the first obstacle or second obstacle is minimized, and the method comprises stopping the vehicle within the stopping distance and minimizing an encounter with the first obstacle and the second obstacle.

17. The method of claim 14, further comprising modulating a rate of deceleration of the vehicle.

18. The method of claim 14, further comprising limiting a rate of deceleration to less than a maximum rate of deceleration.
